(19) United States
(12) Patent Application Publication
(10) Pub. No.: US 2008/0165733 A1
(43) Pub. Date: Jul. 10, 2008

(54) METHOD AND APPARATUS FOR THE DYNAMIC AND CONTENTION-FREE ALLOCATION OF COMMUNICATION RESOURCES

(75) Inventors: Weimin Xiao, Barrington, IL (US); Amitava Ghosh, Buffalo Grove, IL (US); Rapeepat Ratasuk, Hoffman Estates, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/933,485

(22) Filed: Nov. 1, 2007

Related U.S. Application Data
(60) Provisional application No. 60/884,267, filed on Jan. 10, 2007.

(51) Int. Cl. H04Q 7/20; H04B 1/69

(52) U.S. Cl. 370/330; 375/130; 455/509

(57) ABSTRACT

A method and apparatus for assigning a communication resource is disclosed. The method includes allocating a channel by a base station or Node B 102. The base station or Node B detects an energy level transmitted on the channel wherein the energy level may contention-free for a plurality of user equipment 104. The base station or Node B assigns time frequency resources for at least one of the plurality of user equipment wherein the time frequency resources are proportional to the detected energy level.

### FIELD OF THE INVENTION

The present invention relates generally to assigning uplink communication resources and, in particular, to the dynamic and contention-free allocation of uplink communication resources.

### BACKGROUND

User equipment that is not synchronized to a communication network can use random access to request uplink transmission or communication resources from a base station or Node B. For user equipment that are synchronized, however, a contention-based mechanism such as random access is not efficient when the traffic to be sent on the communication channel is delay sensitive.

When user equipment is not scheduled for uplink data transmissions, user equipment transmits a scheduling request indicator to a base station or Node B where the indicator is an initial resource request. Upon receipt, the base station or Node B responds to the user equipment with an uplink scheduling grant for a minimum assignment, such as a resource grant, for the user equipment to transmit the actual scheduling request and possibly with some data. The uplink scheduling grant can be asynchronous with the scheduling request indicator to allow for greater scheduling flexibility. Although several methods can be used to transmit the scheduling request indicator, an existing physical layer channel is used to reduce complexity.

One such method is to use the channel quality indicator (CQI) channel where one out of n available CQI values can be treated as a scheduling request indicator instead as of a CQI. Therefore, the resolution of the CQI report is reduced. Moreover, a CQI may not be transmitted or may be transmitted at an interval which is less frequent than the required scheduling interval. In order to force user equipment to report CQI, all user equipment is required to periodically report CQI with a maximum reporting interval that satisfies latency requirements. This, however, creates unnecessary overhead and may significantly reduce the uplink capacity, which can be especially problematic for Voice over Internet Protocol (VoIP) and other best-effort services where CQI reporting is rarely required.

User equipment with best-effort or delay insensitive traffic that does not use CQI reports may use non-synchronous random access to request uplink resources. In this case, however, collision of requests is possible. For user equipment with delay sensitive traffic, collision-free non-synchronous random access procedures to request uplink resources can be defined by making a subset of preamble sequences available. In an embodiment, preamble sequences can be exclusively reserved for scheduling request purposes. The user equipment is assigned a reserved sequence at a specific time to be used as a scheduling request indicator. This configuration eliminates collusions and provides a mechanism for the user equipment to transmit the scheduling request indicator without using an uplink overhead channel. Capacity on the non-synchronized random access channel is corresponding reduced, however, and more time-frequency regions may be needed to maintain low collision probability for other random access users.

In an alternative approach, the Node B can automatically assign an uplink scheduling grant without the need for receiving a scheduling request indicator. This can be done periodically or in some other fashion depending on various Quality of Service parameters. This approach, however, results in reduced latency compared to the approaches where a scheduling request indicator is used. In addition, resources are wasted if there is no need for an uplink data to be transmitted by the user equipment. Because one resource block is expected to be the minimum uplink resource assignment, the wasted resource is significant.

In view of the foregoing, there is a need to have a dynamic and contention-free method to request uplink communication resources that uses a scheduling request.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a communication network used in accordance with some embodiments of the invention.

FIG. 2 is a call flow diagram of a request for communication resources used according to the prior art.

FIG. 3 is an illustration of a subframe including multiple subcarriers as used in accordance with an embodiment of the present invention.

FIG. 4 is an illustration of the energy level sent on a subcarrier for a common scheduling request indicator in accordance with an embodiment of the present invention.

FIG. 5 is a flow chart of an allocation and assignment of communication resources made in accordance with an embodiment of the present invention.

FIG. 6 is another flow chart of allocation and assignment of communication resources made in accordance with an embodiment of the present invention.

FIG. 7 is a flow chart of a request of communication resources made in accordance with an embodiment of the present invention.

FIG. 8 is another flow chart of a request of communication resources made in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a dynamic and contention-free method and apparatus to request uplink communication resources using a scheduling request. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a dynamic and contention-free method and apparatus to request uplink communication resources using a scheduling request described herein. The non-processor circuits may include, but are not limited to, a radio receiver, a radio transmitter, signal drivers, clock circuits, power source circuits, and user input devices. As such, these functions may be interpreted as steps of a method to perform a dynamic and contention free request for uplink communication resources using a scheduling request. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In an embodiment of the present invention, a method for assigning a communication resource is provided. The method includes allocating a specific channel that user equipment use to request a communication resource from a base station or a Node B. The method also detects an energy level at the base station or Node-B transmitted on the channel by at least one of a plurality of available user equipment that communicates with the base station or the Node B. Upon detection of an energy level of the signal transmitted on the common time-frequency resource, the base station or Node B assigns time frequency resources for at least one of the plurality of user equipment wherein the assigned time frequency resources are proportional to the detected energy level so that the number of time frequency resources varies according to the amount of energy detected over a predefined thresholds. In an embodiment, the channel can be a common scheduling request indicator channel where the availability of the channel can occur periodically. A cell radio network temporary identifier can be used to identify uplink resource grant for assigning the time frequency resources. In an embodiment, the method can also delay allocating time frequency resources for at least one of the plurality of user equipment according to, for example, the number of request indicators detected and accumulated.

The present invention can include receiving a scheduling request from at least one of the plurality of user equipment. The scheduling request is spread by a spreading code wherein the each of the plurality of user equipment uses a unique spreading code based on the size of assigned resource. In addition, the present invention can include allocating the communication resource for the at least one of the plurality of user equipment in response to the scheduling request.

In another embodiment of the present invention, a method of requesting a channel resource is provided. According to this embodiment, the method includes sending an indicator on an allocated channel wherein the allocated channel is a common time-frequency region for use by a plurality of user equipment. The method also includes monitoring an uplink grant for a specific identifier and sending a scheduling request on an assigned shared data channel using a code specific to each of the plurality of user equipment. The indicator for one of the plurality of user equipment can be combined, including but not limited to being combined over the air, with indicators for others of the plurality of user equipment. In addition, the code is a spreading code specific for each of the plurality of user equipment and the length of the spreading codes is based on the size of the communication resources assigned. The plurality of user equipment can be multiplexed using code division multiplexing.

In yet another embodiment, an apparatus for assigning communication resources is provided. The apparatus can include a transceiver for transmitting and receiving signals, and a controller coupled to the transceiver. The controller is configured to allocate a channel; detect an energy level of a signal received on the channel by the transceiver; assign time frequency communication resources for at least one of the plurality of user equipment wherein the number of time frequency resources is proportional to the detected energy level, and sending the time frequency communication resources to the at least one of the plurality of user equipment by the transceiver. The controller can also schedule the channel to be a common scheduling request indicator channel that occurs periodically. In addition, the controller can allocate the time frequency resource when the detected energy level is above a predefined threshold and delay allocating time frequency resources for at least one of the plurality of user equipment.

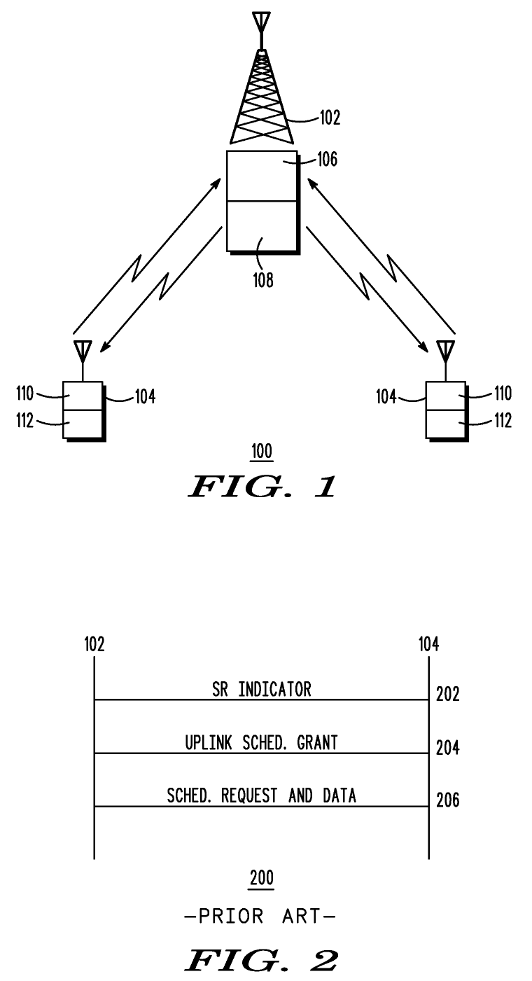

Turning to FIG. 1, a wireless communication network and system 100 used in connection with embodiments of the present invention is shown. Network 100 can be any of a variety of different wireless communication systems currently being used and under development including code division multiple access (CDMA), CDMA2000, wide band CDMA, (W-CDMA), global system of mobile communication (GSM), universal telecommunication mobile system (UTMS), orthogonal frequency division multiplexing (OFDM) including Discrete Fourier Transform Spreading OFDM (DFT-SOFDM) and Voice over IP (VoIP) networks.

The wireless communication network 100 is divided into multiple radio access networks or cells such that each cell covers a given area. Within each cell, there are certain hardware components that are necessary to conduct the wireless communications. These hardware components include, but are not limited to, a base station or Node B 102 such that each cell includes its own base station 102. A base station 102 transmits and receives data with user equipment 104 that is within the cell. User equipment can include mobile stations, cellular phones, personal digital assistance, laptop computers and other devices. Each base station 102 includes a transceiver 106 and controller 108. Likewise, user equipment 104 includes a transceiver 110 and controller 112 so that the user equipment transmits and receives data with the base station.

User equipment 104 can be in a number of different states while operating in the communication network 100. Such states include an idle state where the user equipment is present within the network but is not communicating with a base station or other user equipment. The user equipment can also be in an active state where communication signals are sent between the user equipment 104 and the base station 102. Signals sent from the user equipment 104 to the base station 102 are sent on an uplink channel, and signals sent from the base station 102 to the user equipment are sent on a downlink channel. In the idle state, uplink and downlink channel resources are not allocated between the user equipment 104 and the base station 102. When user equipment 104 switches from the idle state to the active station, the user equipment must request from the base station 106 and then receive from the base station a communication resource including an uplink channel resource.

As shown in FIG. 2, one approach 200 of the prior art to assign an uplink channel resource using a channel quality indicator (CQI) resource. The user equipment 104 transmits 202 a scheduling request indicator to the base station or Node B 102 on the CQI channel where one of the various CQI values is used by the user equipment 104. In response the Node B 102 responds 204 in an asynchronous fashion to the user equipment with an uplink scheduling grant for a minimum assignment of one resource block. With the uplink scheduling grant the user equipment is permitted to request an allocation of resources in order to operate on the uplink channel in the active state. The user equipment 104 then sends 206 a signal to the Node B 102 requesting amount or uplink channel resources that are needed. The Node B can then allocate and assign the resources according to the request and other network considerations. As can be appreciated, other similar methods are known and include automatically assigning the uplink scheduling grant according the step 204 without the need for a scheduling request indicator. These approaches present latency issues and unnecessarily increase overhead requirements.

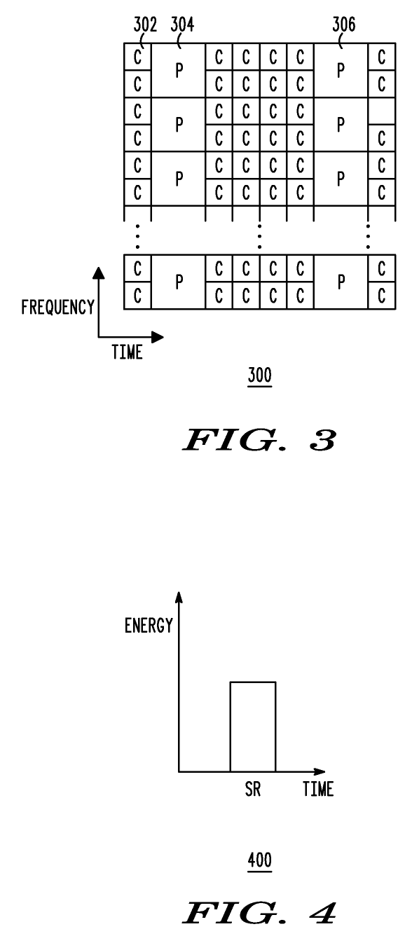

FIG. 3 is an illustration of a subframe 300 of a communication channel used between a base station or Node B 102 and user equipment 104. In an embodiment, the subframe 300 extends for 0.5 msecs. although it is understood that the span of the subframe 300 can vary according to the needs and requirement of the network and the various network components. As shown, the subframe 300 is divided into multiple subcarrier time blocks along the x-axis. For each subcarrier time block, there are multiple subcarrier frequencies along the y-axis. Accordingly, each subframe 300 is divided into various subcarriers that include data subcarriers 302 and pilot subcarriers 304. As known, the data subcarriers are used to convey data between user equipment 104 and the Node B, and the pilot subcarriers are used for control information used by the user equipment 104 and the Node B as a part of setting up and controlling the uplink and downlink channels.

An embodiment of the present invention uses the subframe of an uplink communication. As seen in FIG. 3, one of the pilot subframes can be designated as a common scheduling request feedback channel 306. The common scheduling request feedback channel 306 is monitored by Node B 102 to detect when user equipment 104 desires to send a scheduling request to the Node B 102 to allocate uplink channel resources. When user equipment 104 determines that uplink channel resources are needed, the user equipment 104 sends a signal having a given energy level to the Node B or base station 102. In an embodiment, this energy level is designated as a common scheduling request indicator and is a common signal that is sent by any of the user equipment 104 that is operating in the network 100. When the Node B 102 detects a energy level of a given level, the Node B determines that user equipment is desirous of sending a scheduling request indicator to the Node B although the Node B may not know which of the user equipment operating in its vicinity is requesting an uplink channel allocation.

FIG. 4 illustrates the energy level 400 sent on a subcarrier for the common scheduling request indicator 306. The Node B 102 detects the energy level to determine the amount of resources to be assigned. In an embodiment, user equipment 104 sends energy on the common scheduling request feedback channel 306 of a given level, and when the Node B 102 detects the energy level on the channel has reached a given threshold the Node B determines at least one of the user equipment operating within a cell is requesting uplink channel resources. As the energy level on the common scheduling resource indicator channel 306 increases, the Node B 102 can determine that there are increasing number of user equipment in the cell that are in need of uplink channel resources. The use of a threshold avoids the situation of the Node B detecting a scheduling request indicator when one is not been sent. In addition, the threshold allows the Node B to determine the number of user equipment sending a scheduling request indicator of the channel 306 by dividing the energy level detected on the channel by the threshold value.

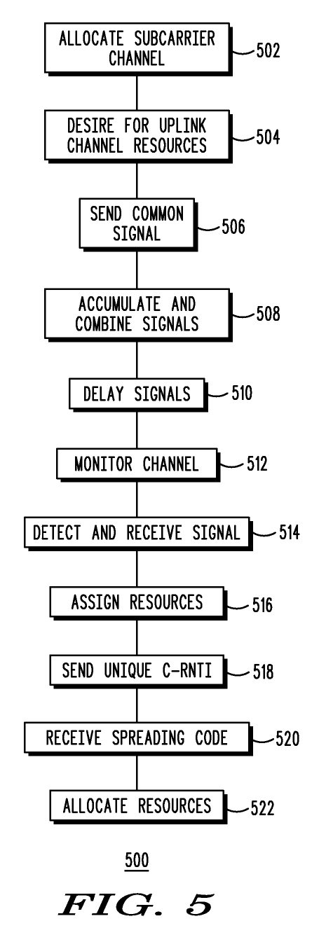

Turning to FIG. 5, a flow chart of a method 500 of assigning a communication resource is shown. In an embodiment, the method 500 is used for OFDM communication networks including Discrete Fourier Transform Spread OFDM communication networks. To begin, the communication network allocates 502 one of the subcarriers in a subframe to be used by the Node B 102 and user equipment 104 for assigning a communication resource of the network for communications. With the knowledge that such a channel has been allocated, a user of user equipment 104 can desire to acquire 504 uplink communication resources in order to communication with other user equipment within or without communication network 100. As a part of a dynamic contention-free access procedure in accordance with the present invention, the user equipment 104 sends 506 a common signal on a common-time frequency region within the subframe 300.

The common signal can be common scheduling request indicator that is sent on a designated pilot subcarrier of the subframe. The designated subframe can be a common scheduling request feedback channel 306 of the subframe 300. The common signal can have a predetermined energy level that can be read by the Node B or base station 102. The predetermined energy level can be at least equivalent to a threshold and can be on the order of a single CQI report. While the common channel is always on and occurs periodically, the channel does not need to be used in every frame by all user equipment operating unlike a CQI report.

In an embodiment, the common scheduling request indicators for multiple user equipment 104 operating with the Node B are accumulated and combined 508. This combination of indicators can provide an approximate indication of the number of requests being sent at during a subframe by determining the proportion of the energy level and the threshold value. In the event that the scheduling request indicators are accumulated, the transmittal and use by the Node B can be delayed 510 until a predetermined event occurs such as the load in the network or certain amount of resources are available or until a predetermined threshold value is reached for the energy level. Those unique spreading codes are code multiplexed as a part of the accumulation of indicators.

The Node B or base station 106 monitors 512 the common scheduling request feedback channel 306 at the period that user equipment 104 transmits on the pilot subcarrier. At a time after user equipment 104 transmits an energy level of the threshold value, the Node B or base station 106 detects and receives 514 the energy level on the monitored common scheduling request feedback channel. Accordingly, the Node B 106 dynamically assigns 516 resources according to uplink resource grant procedures of the communication network protocol. The assigned resources can be time frequency resources and uplink communication channel time frequency resources. For OFDM and DFT-SOFDM systems, the Node B 106 may use a special cell radio network temporary identifier (C-RNTI) that is designated for as a common scheduling request indicator. The amount of resources assigned corresponds to the number of resource blocks that the Node B allocates for the various user equipment communicating with the Node B to transmit scheduling requests. In an embodiment, the amount of resources assigned is dynamic based on the amount of detected energy found on the common scheduling request feedback channel 306. As stated, the amount of detected energy can be proportional to the number of user equipment sending scheduling request indicators. After assigning the C-RNTI, the Node B 106 sends 518 the unique C-RNTI to each of the user equipment. In an embodiment, each of the user equipments communicating with the Node B uses a unique spreading code for the scheduling request upon receipt of the C-RNTI. The Node B or base station 102 receives 520 the unique spreading code and in response to the request and allocates 522 the requested uplink resources for the user equipment.

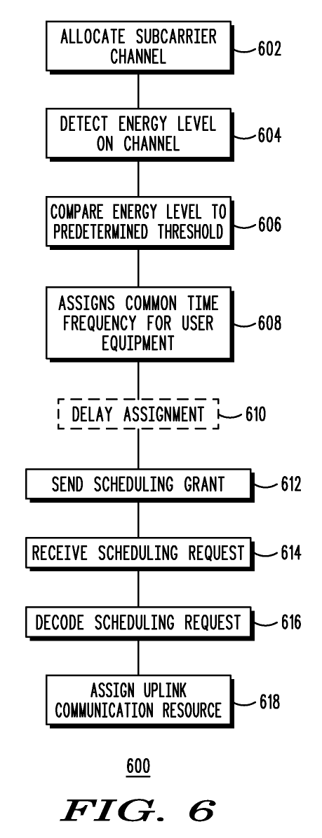

FIG. 6 is another flow chart of a Node B allocating and assigning uplink communication resources in accordance with the principles of the present invention. To begin, the communication network allocates 602 one of the subcarriers in a subframe to be used by the Node B 102 and user equipment 104 for assigning a communication resource of the network for communications. The Node B or base station 102 detects 604 on energy level of a signal sent on the common time-frequency resource allocated for this purpose in step 602. In an embodiment, the received signal is an accumulation of signals sent by a plurality of user equipment in the network. The Node B or base station 102 compares 606 the energy level of the received signal to a set of pre-defined thresholds. The pre-defined threshold can correspond to the number of user equipment sending signals on the allocated channel. Thus, if the compared signal is equal to or greater than one predefined threshold, the Node B has determined that there is at least one user equipment to be requesting resources and if the compared signal is equal to or greater than another predefined threshold, the Node B has determined that there is another number of equipment to be requesting resources. A scheduler in the Node B assigns 608 common time frequency for the plurality of user equipment to send actual scheduling requests for uplink communication resources. The amount of common time frequency resources assigned is based on the detected energy levels. In an embodiment, the assignment can be delayed 610 until a certain number of indicators are received. The scheduling grant that is sent 612 by the Node B 102 can be masked using a special C-RNTI code. After sending the C-RNTI code, the Node B receives 614 scheduling requests from the plurality of user equipment requesting uplink communication resources. The Node B decodes 616 these scheduling requests using a user equipment specific code to determine the user equipment and the amount of resources that each user equipment is requesting. Based on the decoded scheduling request, the Node B 102 assigns 618 the uplink communication resource where the grant is based on the actual scheduling request instead of a scheduling request indicator.

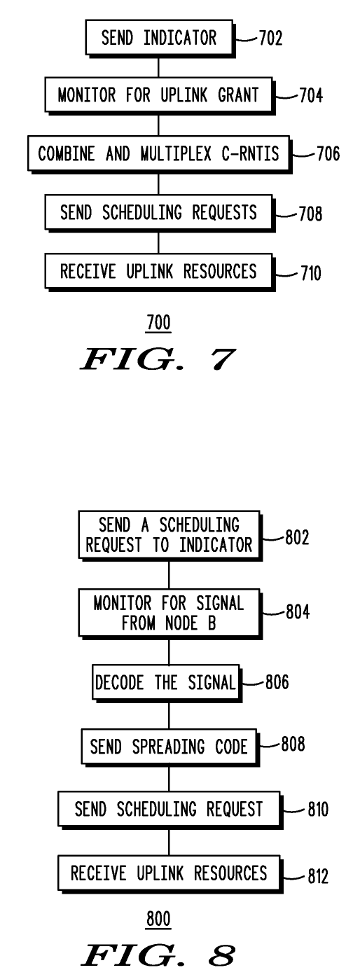

FIG. 7 is a flow diagram of user equipment making a request 700 for uplink communication resources in accordance with the principles of the present invention. To begin, user equipment 104 that needs uplink communication resources to communicate with a Node B 102, user equipment 104 or other user equipment sends 702 an indicator on a channel allocated for scheduling request indicators. In an embodiment, the channel is a common scheduling request feedback channel of an OFDM subframe and can be pilot subcarrier used in the subframe. Moreover, the allocated channel can occur periodically and can be used by a plurality of user equipment operating within range of the Node B or base station 106. The channel can also be an uplink frequency channel and can be a common time frequency region used by a plurality of user equipment.

After sending the scheduling request indicator, the user equipment monitors 704 for an uplink grant. In an embodiment, the user equipment is monitoring for a specific indicator that can include a C-RNTI designated for that particular user equipment. The C-RNTI can be combined and multiplexed 706 with other C-RNTIs used for other user equipment. Upon receipt of the specific indicator, the user equipment 104 sends 708 a scheduling request on an assigned shared data channel. The scheduling request can be spreading code specifically assigned to the user equipment. For an embodiment of the present invention, each of the user equipment that does not have an assigned uplink grant can send a scheduling request indicator using an available control channel instead of the channel assigned for scheduling request indicators. After sending a scheduling request, each user equipment receives 710 an allotment of uplink channel resources. The allotment of resources can be proportional to the size and energy level of the scheduling request indicator and the scheduling request.

Turning to FIG. 8, an alternative description of user equipment requesting uplink channel resources is shown by way of a flow chart. When user equipment 104 needs to have uplink communication resources that have not already been assigned, user equipment 104 sends 802 a scheduling request indicator to a base station or Node B 102 over a common time frequency resource. The common time frequency resource can be dedicated subcarrier of a subframe in an OFDM or DFT-SOFDM system. As described, the Node B will send a C-RNTI or other suitable signal to the user equipment in response to the scheduling request indicator. The user equipment 104 monitors 804 for the appropriate signal sent by the Node B 102. Once detected and received, the user equipment decodes 806 the signal, which can be C-RNTI that has masked the grant of a channel assignment for the user equipment to use for sending a scheduling request. With the decoded C-RNTI, the user equipment 104 selects 808 the appropriate spreading code that will be used to send the scheduling request. The spreading code can be based on the user equipment 104 identifier together with the amount of resources that is assigned for use in the uplink channel. The user equipment 104 then sends 810 the actual scheduling request, to the Node B or base station 102. The scheduling request can also be multiplexed with other scheduling requests for other user equipment. Upon receipt of the actual scheduling request, the Node B will allocate the appropriate resources according to the size of the request, which will be received 812 by the user equipment. In an embodiment where the user equipment does not receive the grant of channel assignment by the C-RNTI within a defined period of time, the scheduling request indicator can be resent to the Node B.

In view of the foregoing, an example of the operation of the present invention will be explained. A Node B 102 operates within a communication network 100 and serves a given area. Within that area, a plurality of user equipment 104 can be operating where some of the user equipment are active and participating in communication with the Node B 102 while other user equipment are idle and not participating in communication. When at least one of the idle user equipment needs uplink communication resources with the Node B so as to be in active communication with the Node B or base station and other user equipment within or without the communication network, the user equipment sends a scheduling request indicator over a common scheduling request indicator feedback channel. The scheduling request indicator can be a given energy level of a predetermined threshold. Moreover, the scheduling request indicator can be multiplexed with other scheduling request indicators from other user equipment. The common scheduling request indicator feedback channel can be a designated pilot subcarrier in a 5 msec. subframe of an OFDM channel. As such, the common scheduling request indicator can occur periodically as a common time-frequency region of the subframe.

When the Node B 102 detects an energy level on the common time-frequency region of the subframe, it is determined if the energy level reaches a threshold value that would indicate that at least one user equipment 104 has sent a scheduling request indicator. The Node B 106 can determine how many user equipment 104 are in need of resources by determining the proportion of energy with respect to the threshold energy level. For the number of user equipment 104 sending scheduling request indicators on the channel, the Node B 102 allocates an appropriate number of unique C-RNTIs and assigns those C-RNTIs to the user equipment. The amount of resources assigned is also proportional to the energy levels that are sent by the user equipment. In an embodiment, the Node B 102 can accumulate a number of scheduling request indicators and delay sending the C-RNTIs to the user equipment until the amount of scheduling requests reaches a predetermined level. If the synchronous non-adaptive H-ARQ is adopted for the uplink channel, the assigned resource can not be already reserved for retransmission by other user equipment within the network 100.

The user equipment monitors for the uplink grants sent by the Node B or base station for the reserved C-RNTI. Upon detection of the appropriate C-RNTI, the user equipment sends a scheduling request on the assigned data channel. In an embodiment the user equipment sends a specific spreading code for that user equipment. Since all user equipment that transmit the common scheduling request indicator can be addressed using the same reserved C-RNTI, their scheduling request can be code division multiplexed together. Alternatively, a fixed length spreading code can be used with repetition to match the actual number of resource blocks needed. Upon receipt of the scheduling request sent by the user equipment, the Node B 102 allocates for the requested uplink resources according to the principles of the network protocol.

According to the foregoing, a synchronous scheduling process can be achieved where the requests are contention-free. In addition, the requests does not provide for a burden on overhead.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for assigning a communication resource, the method comprising:
allocating a channel;
detecting an energy level transmitted on the channel, and
assigning time frequency resources for at least one of a plurality of user equipment wherein the time frequency resources are proportional to the detected energy level.

2. The method according to claim 1 wherein detecting an energy level transmitted on the channel further comprises detecting an energy level above a predefined threshold.

3. The method according to claim 1 wherein assigning time frequency resources occurs on an uplink channel and further comprises using a cell radio network temporary identifier to dynamically assign regular uplink resource grant for assigning the time frequency resources.

4. The method according to claim 1 further comprising accumulating a series of detections of energy levels being transmitted on the channel.

5. The method according to claim 1 further comprising delaying allocating time frequency resources for at least one of the plurality of user equipment.

6. The method according to claim 1 further comprising receiving a scheduling request from at least one of the plurality of user equipment on the assigned time frequency resources.

7. The method of claim 1 wherein the channel comprises a fixed time-frequency resource within an orthogonal frequency multiple access network.

8. A method of transmitting uplink control data, the method comprising:
sending an indicator on an allocated channel wherein the allocated channel is a common time-frequency region for use by a plurality of user equipment;
monitoring an uplink grant for a specific identifier;
sending a UL control/data on an assigned shared data channel using a code specific to each of the plurality of user equipment.

9. The method of claim 8 wherein the uplink control data is a scheduling request for uplink channel resources.

10. The method according to claim 8 wherein the indicator for one of the plurality of user equipment is combined with indicators for others of the plurality of user equipment.

11. The method according to claim 8 wherein the allocated channel occurs periodically for use by the plurality of user equipment.

12. The method according to claim 8 wherein the identifier is a cell radio network temporary identifier.

13. The method according to claim 8 wherein the code is a spreading code specific for each of the plurality of user equipment.

14. The method according to claim 8 wherein the codes for each of the plurality of user equipment are multiplexed.

15. The method according to claim 8 wherein each of the plurality of user equipment with no assigned uplink grant for a specific time period re-transmits the indicator.

16. An apparatus for assigning communication resources, the apparatus comprising:
a transceiver for transmitting and receiving signals, and
a controller coupled to the transceiver, the controller operable to allocate a channel, detect an energy level of a signal received on the channel by the transceiver, assign time frequency communication resources for at least one of the plurality of user equipment wherein the number of time frequency resources is proportional to the detected energy level and send the time frequency communication resources to the at least one of the plurality of user equipment by the transceiver.

17. The apparatus according to claim 16 wherein the controller schedules the channel to be a common scheduling request indicator channel that occurs periodically.

18. The apparatus according to claim 16 wherein the controller allocates the time frequency resource when the detected energy level is above a predefined threshold.

19. The apparatus according to claim 16 wherein the controller delays allocating time frequency resources for at least one of the plurality of user equipment.

20. The apparatus according to claim 16 wherein the controller allocates the communication resource when a scheduling request is received from at least one of the plurality of user equipment by the transceiver.
